(19) United States
(12) Patent Application Publication
(10) Pub. No.: US 2009/0102432 A1
(43) Pub. Date: Apr. 23, 2009

(54) BATTERY CHARGER

(75) Inventors: MING-CHIH HSIEH, Tu-Cheng (TW); KUO-SHENG CHAO, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/965,751

(22) Filed: Dec. 28, 2007

(30) Foreign Application Priority Data
Oct. 19, 2007 (CN) 200710202145.X

(51) Int. Cl. H02J 7/00

(52) U.S. Cl. 320/163

(57) ABSTRACT

An exemplary battery charger includes an input interface arranged to connect to a DC power source, having a positive terminal and a negative terminal; an output interface arranged to connect to a battery, having a positive terminal and a negative terminal; a switch circuit connected between the positive terminals of the input interface and the output interface, comprising a control terminal; a detecting resistor connected between the negative terminals of the input interface and the output interface; a detecting circuit connected between the negative terminals of the input interface and the output interface to detect a voltage across the detecting resistor and output a digital signal; and a processor receiving the voltage signal to determine whether the battery is fully charged and generate a voltage signal to the control terminal of the switch circuit via an inverting circuit for turning off the switch circuit when the battery is fully charged.

### BACKGROUND

1. Field of the Invention

The present invention relates to a charger for a battery.

2. Description of Related Art

The battery packs for portable power tools, outdoor tools and certain kitchen and domestic appliances may include rechargeable batteries, such as lithium, nickel cadmium, nickel metal hydride and lead-acid batteries, so that they can be recharged rather than replaced. Thereby a substantial cost saving is achieved.

Rechargeable batteries are charged by a DC battery charger. Generally, battery chargers include an alternating current (AC) to direct current (DC) (or DC to DC) adapter containing an AC to DC (or DC to DC) converter for generating a substantially constant current to charge the battery to a nominal battery voltage. The battery generates heat when charged by the charger, and may be burned if charged for a long time.

### SUMMARY

An exemplary battery charger comprises an input interface arranged to connect to a DC power source, having a positive terminal and a negative terminal; an output interface arranged to connect to a battery, having a positive terminal and a negative terminal; a switch circuit connected between the positive terminals of the input interface and the output interface, comprising a control terminal; a detecting resistor connected between the negative terminals of the input interface and the output interface; a detecting circuit connected between the negative terminals of the input interface and the output interface to detect a voltage across the detecting resistor and output a digital signal; and a processor receiving the voltage signal to determine whether the battery is fully charged and generate a voltage signal to the control terminal of the switch circuit via an inverting circuit for turning off the switch circuit when the battery is fully charged.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a schematic diagram of a battery charger in accordance with an embodiment of the present invention having a switching circuit, a detecting circuit, and an inverting circuit;

FIG. 2 is a circuit diagram of the switch circuit and the inverting circuit of FIG. 1; and

FIG. 3 is a circuit diagram of the detecting circuit of FIG. 1.

### DETAILED DESCRIPTION

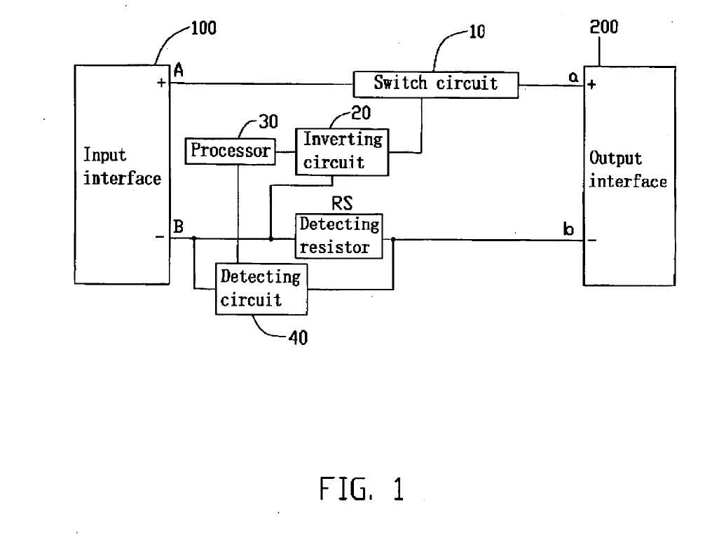

Referring to FIG. 1, a battery charger in accordance with an embodiment of the present invention includes an input interface 100 having a positive terminal A and a negative terminal B, an output interface 200 having a positive terminal a and a negative terminal b, a switch circuit 10 connected between the positive terminals A and a of the input and the output interfaces 100 and 200, a detecting resister RS connected between the negative terminals B and b of the input and the output interfaces 100 and 200, an inverting circuit 20 connected between a control terminal of the switch circuit 10 and the negative terminal B of the input interface 100, a processor 30 connected to the inverting circuit 20, and a detecting circuit 40 connected between the negative terminals B and b of the input and the output interfaces 100 and 200 and further connected to the processor 30. The input interface 100 is arranged to connect to a DC power source. The output interface 200 is arranged to connect to a battery.

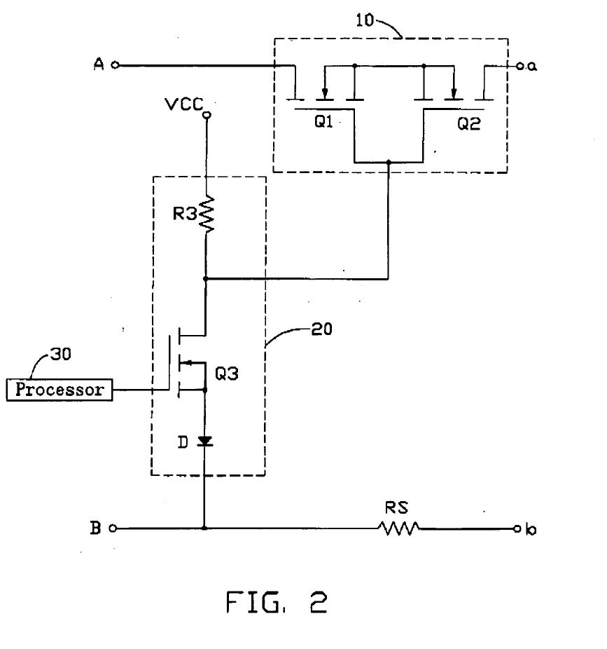

Referring to FIG. 2, the switch circuit 10 includes two NMOS transistors Q1 and Q2. The drain of the NMOS transistor Q1 is connected to the positive terminal A of the input interface 100. The source of the NMOS transistor Q1 is connected to the drain of the NMOS transistor Q2. The source of the NMOS transistor Q2 is connected to the positive terminal a of the output interface 200. The gate of the NMOS transistor Q1 is connected to the gate of the NMOS transistor Q2 as the control terminal of the switch circuit 10.

The inverting circuit 20 includes an NMOS transistor Q3, a diode D, and a resistor R3. The drain of the NMOS transistor Q3 is connected to a power source VCC via the resistor R3. The source of the NMOS transistor Q3 is connected to the anode of the diode D, and the cathode of the diode D is connected to the negative terminal B of the input interface 100. The gate of the NMOS transistor Q3 is connected to the processor 30.

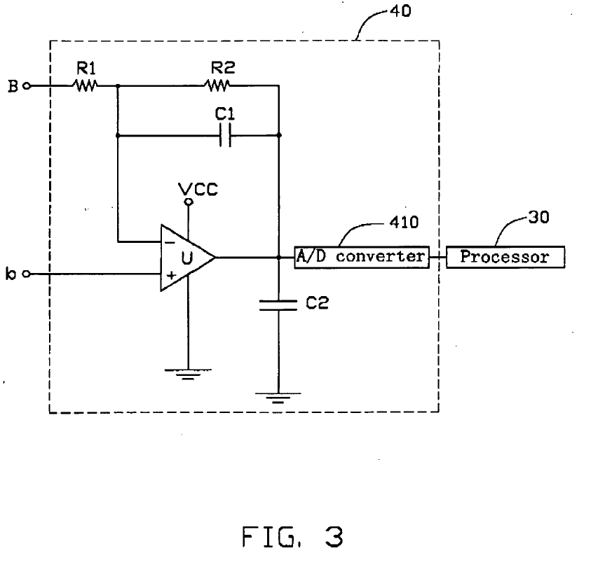

Referring to FIG. 3, the detecting circuit 40 includes two resistors R1 and R2, a comparator U, two capacitors C1 and C2, and an analog-to-digital (A/D) converter 410. The inverting terminal of the comparator U is connected to the negative terminal B of the input interface 100 via the resistor R1. The resistor R2 and the capacitor C1 are connected in parallel between the inverting terminal and the output terminal of the comparator U. The non-inverting terminal of the comparator U is connected to the negative terminal b of the output interface 200. The output terminal of the comparator U is connected to the processor 30 via the A/D converter 410 and grounded via the capacitor C2.

In this embodiment of the invention, the processor 30 generates a high level voltage signal at the beginning of charging a battery by the charger. Therefore, the NMOS transistor Q3 is turned on for turning off the switch circuit 10. At this time a voltage signal output by the comparator U as an original value of the charger, which is proportional to the voltage drop across the detecting resistor RS, is received by the processor 30 via the A/D converter 410 for saving as a variable K1. The A/D converter 40 is used to convert the analog voltage output by the comparator into a digital voltage signal.

The processor outputs a low level voltage signal after saving the variable K1. Therefore, the NMOS transistor Q3 is turned off for turning on the switch circuit 10 to start charging. And produce a voltage difference between the inverting terminal and the non-inverting terminal of the comparator U which is equal to a voltage on the detecting resistor RS. The comparator U outputs another voltage signal, and the voltage signal is received by the processor 30 via the A/D converter and saved as a variable K2. The processor 30 subtracts the variable K1 from K2, and compares the difference with a reference value K3. If the difference is greater than the reference value K3, the charging is not complete. Therefore, the processor 30 keeps outputting the low-level voltage signal, and updates the variable K2. If the difference is less than the reference value K3 or equal to the reference value K3, the charging is complete. Therefore, the processor 30 outputs a high level voltage signal to stop the charging process. The reference value K3 is equal to a voltage generated by the comparator when the battery is fully charged.

Therefore, the charger can automatically stop charging of the battery when the battery being charged by the charger is fully charged, thus protecting the battery.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

1. A battery charger comprising:
an input interface arranged to connect to a DC power source, having a positive terminal and a negative terminal;
an output interface arranged to connect to a battery, having a positive terminal and a negative terminal;
a switch circuit connected between the positive terminals of the input interface and the output interface, comprising a control terminal;
a detecting resistor connected between the negative terminals of the input interface and the output interface;
a detecting circuit connected between the negative terminals of the input interface and the output interface to detect a voltage across the detecting resistor and output digital signals; and
a processor receiving a first digital signal from the detecting circuit upon the condition that the switch circuit is off, receiving a second digital signal from the detecting circuit upon the condition that the switch circuit is on, subtracting the first digital signal from the second digital signal to get a third digital signal, comparing the third digital signal with a reference value to determine if the battery is fully charged, and generating a voltage signal to the control terminal of the switch circuit via an inverting circuit for turning off the switch circuit when the battery is fully charged.

2. The battery charger as claimed in claim 1, wherein the switch circuit comprises a first NMOS transistor and a second NMOS transistor, the drain of the first NMOS transistor is connected to the positive terminal of the input interface, the source of the first NMOS transistor is connected to the drain of the second NMOS transistor, the source of the second NMOS transistor is connected to the. positive terminal of the output interface, the gate of the first NMOS transistor is connected to the gate of the second NMOS transistor and together serve as the control terminal of the switch circuit to connect the inverting circuit.

3. The battery charger as claimed in claim 1, wherein the inverting circuit comprises a third NMOS transistor, a diode, and a third resistor, the drain of the third NMOS transistor is connected to a power source via the third resistor, the source of the NMOS transistor is connected to the anode of the diode, and the cathode of the diode is connected to the negative terminal of the input interface, the gate of the third NMOS transistor is connected to the processor to receive the voltage signal, and the drain of the third NMOS transistor is connected to the control terminal of the switch circuit to control the switch circuit to turn on and off according to the voltage signal.

4. The battery charger as claimed in claim 1, wherein the detecting circuit comprises a first resistor, a second resistor, a comparator, a capacitor, and an A/D converter, an inverting terminal of the comparator is connected to the negative terminal of the input interface via the first resistor, the second transistor and the capacitor are connected in parallel between the inverting terminal and an output terminal of the comparator, a non-inverting terminal of the comparator is connected to the negative terminal of the output interface, the output terminal of the comparator is connected to the processor via the A/D converter for transmitting the digital signal according to a voltage on the detecting resistor.

5. (canceled)

6. The battery charger as claimed in claim 4, wherein the reference value is equal to a voltage generated by the comparator when the battery is fully charged.

7. A compensating method in using a battery charger, the compensating method comprising: providing an input interface with a positive terminal and a negative terminal;
an output interface with a positive terminal and a negative terminal;
a switch circuit connected between the positive terminals of the input interface and the output interface;
a detecting resistor connected between the negative terminals of the input interface and the output interface;
a detecting circuit connected between the negative terminals of the input interface and the output interface;
a processor connected to the detecting circuit, wherein a reference value is stored in the processor; and
an inverting circuit connected between the processor and the switch circuit;
connecting a DC power source to the input interface;
connecting a battery to the output interface;
detecting a first digital value between the negative terminals of the input interface and the output interface by the detecting circuit upon the condition that the switch circuit is off, and sending the first digital value to the processor;
detecting a second digital value between the negative terminals of the input interface and the output interface by the detecting circuit upon the condition that the switch circuit is on, and sending the second digital value to the processor;
subtracting the first digital value from the second digital value to get a third digital value by the processor;
comparing the third digital value with the reference value by the processor;
turning off the switch circuit via the inverting circuit by the processor upon the condition that the third digital value is less than the reference value; and
turning on the switch circuit via the inverting circuit by the processor upon the condition that the third digital value is more than or equal to the reference value.

8. The compensating method as claimed in claim 7, wherein the switch circuit comprises a first NMOS transistor and a second NMOS transistor, the drain of the first NMOS transistor is connected to the positive terminal of the input interface, the source of the first NMOS transistor is connected to the drain of the second NMOS transistor, the source of the second NMOS transistor is connected to the positive terminal of the output interface, the gates of the first and second NMOS transistors are connected to the inverting circuit.

9. The compensating method as claimed in claim 7, wherein the inverting circuit comprises a third NMOS transistor, a diode, and a third resistor, the drain of the third NMOS transistor is connected to a power source via the third resistor, the source of the NMOS transistor is connected to the anode of the diode, and the cathode of the diode is connected to the negative terminal of the input interface, the gate of the third NMOS transistor is connected to the processor, and the drain of the third NMOS transistor is connected to the switch circuit to control the switch to turn on and off according to the processor.

10. The compensating method as claimed in claim 7, wherein the detecting circuit comprises a first resistor, a second resistor, a comparator, a capacitor, and an A/D converter, an inverting terminal of the comparator is connected to the negative terminal of the input interface via the first resistor, the second transistor and the capacitor are connected in parallel between the inverting terminal and an output terminal of the comparator, a non-inverting terminal of the comparator is connected to the negative terminal of the output interface, the output terminal of the comparator is connected to the processor via the A/D converter for transmitting digital signals according to a voltage on the detecting resistor.

11. The compensating method as claimed in claim 10, wherein the reference value is equal to a voltage generated by the comparator when the battery is fully charged.
